(19) United States
(12) Patent Application Publication
(10) Pub. No.: US 2015/0025872 A1
(43) Pub. Date: Jan. 22, 2015

(54) SYSTEM, METHOD, AND APPARATUS FOR MODELING PROJECT RELIABILITY

(71) Applicant: Raytheon Company, Waltham, MA (US)

(72) Inventors: Jon R. Peterson, Anaheim, CA (US); Milena Krasich, Hopkinton, MA (US)

(21) Appl. No.: 13/943,728

(22) Filed: Jul. 16, 2013

(51) Int. Cl. G06F 11/00; G06F 17/50

(52) U.S. Cl. CPC G06F 11/008; G06F 17/5009
USPC 703/13

(57) ABSTRACT

A system, method and apparatus arranged for early-stage reliability-growth models for predicting project reliability at an early stage. These predictions can integrate with an overall system reliability model. Embodiments include predicting reliability of hardware, software, or any other engineering project.

### GOVERNMENT LICENSE RIGHTS

This invention was made with government support under government contract no. FA8807-10-C-0001 awarded by the United States Air Force. The government has certain rights in the invention.

### FIELD

Embodiments pertain to predicting project reliability. Exemplary projects include hardware, software, or both.

### BACKGROUND

Software developers and users desire early reliability estimates for projects or products. Faults (also called bugs or defects) lead to failures, e.g., a system malfunction. Current models for providing early failure rate or reliability estimates are not mathematically accurate. Current models extrapolate the number of remaining faults based on their assumed statistical distribution when appearing as failures. The prior models, which use continuous statistical distributions are mathematically or physically incorrect, and do not provide early reliability estimates. Thus, prior art reliability estimates are unreliable.

Additionally, engineers currently analyze different components, e.g., software and hardware, separately because of the different mathematics. Thus, the project-reliability growth methodology cannot be applied to a system of integrated hardware and software. Software reliability efforts are new for many companies. Engineers adopt some software prediction methods without questioning their adequacy, even when the prediction results are erroneously overly conservative causing unnecessary improvements, such as costly fault protection.

As an example, engineers use reliability growth models to determine how reliability of a product will improve over time. As products mature, engineers can identify failure causes or faults and improve a product by removing or reducing the frequency of failure occurrence, which causes reliability to increase or grow. However, current models fail to predict reliability growth of software accurately because they are based on inappropriate curves, such as the exponential curve, which is used for non-repaired components, not for repairable systems such as software and hardware. These prior art models relied on continuous distributions, such as the exponential distribution, which modeled what was called the instantaneous or hazard failure rate. As such, other's attempts to model faults in a given project have failed by producing incorrect results.

The mathematics applicable to software and hardware is the one that depicts the non-homogenous Poisson Process, NHPP. Here, the failure frequency or MTBF is constant until a change (improvement is made. With series of improvements of reliability growth, this produces a step curve or failure frequency or MTBF that is fitted to a power law curve applicable to all repaired system (predictions and test). Below is an example of software failure data analysis from the IEC 61710 Standard, which can be used to model the failure rate after project completion. This example assumes testing five copies of software, with test termination time:
T=1,850 hours
   The failure times are shown in Table 1.

TABLE 1
Failure times of five tested SW copies

| A | B | C | D | E |
|---|---|---|---|---|
| 96.00 | 552.00 | 1,056.00 | 1,560.00 | |
| 1,224.00 | 1,224.00 | | | |
| 1,392.00 | 1,570.00 | | | |

Accumulated times to failures are then arranged per the time of failure occurrence and shown in Table 2.

TABLE 2
Accumulated times to failure

| | Accumulated |
|---|---|
| | time to failure |
| Failure | (hours) |
| 1 | 96 |
| 2 | 552 |
| 3 | 1,056 |
| 4 | 1,224 |
| 5 | 1,224 |
| 6 | 1,932 |
| 7 | 1,560 |
| 8 | 1,570 |
| T | 1,850 |

Unbiased parameters calculated from equations (21) and (22) are found to be:

β̅=1.134

λ̅=3.16·10⁻⁴

Resultant failure rate (failure frequency) from equation (23) is:

\hat{ω}(T)=9.82·10⁻⁴

Resultant Mean Time between Failures is:

MTBF(T)=1/\hat{α}(T)=1018 hours

This example is simply retrospective, in that it provides information about failures that occurred in the past. This example does not provide information about failures that will happen in the future because it used cumulative time to a failure information to determine its parameters.

The same process, when applied to early reliability predictions and without time to failure information determines the mathematical parameters from the boundary conditions is presented in this invention.

### SUMMARY OF THE INVENTION

Embodiments of the present disclosure can use mathematical functions to determine reliability growth in the future. Embodiments of the present disclosure can use models, such as the power-law model for reliability growth analysis of hardware and software; exemplary models include the following standards: IEC/ANSI 61014, IEC/ANSI 61164, IEC 61710, and MIL-HDBK-189, which are incorporated by reference herein. The first two standards describe reliability growth estimates in hardware test, and analysis; the third, IEC 61710 describes the power mathematical principles and their application for test data analysis, while the handbook is an attempt to explain the methods and its applications on hardware test results adding some assumptions for further future reliability projections. None of them, however, describes making early reliability predictions from the historically known conditions for software or hardware, or software and hardware together. Accordingly, prior art models only considered analyzing failures after design completion, and did not provide early prediction of failure rate.

### BRIEF DESCRIPTION OF THE DRAWINGS

FIG. 1 illustrates a flow chart for generating reliability predictions in accordance with some embodiments.

FIG. 2 illustrates a method of using embodiments to measure and verify performance.

FIG. 3 illustrates a method of combining reliability predictions of different components of a project and in accordance with some embodiments.

FIG. 4 illustrates an exemplary distribution of predicted fault density.

FIG. 5 illustrates exemplary curve of actual number of faults identified.

FIG. 6 illustrates a block diagram of a machine in the form of a computer system in accordance with some embodiments.

FIG. 7 illustrates a diagram of exemplary failure rates, including a sum of failure rates.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The IEC 61710 power-law model, revision3, describes goodness-of-fit tests and methods for estimating the number of removed software faults using the non-homogenous poisson process (NHPP), expressed by the equation where the expected number of observed faults is:

E[n(t)]=\hat{λ}·t^{\hat{β}} (1)

### Where

t=time during fault removal process;
n(t)=number of removed faults as a function of time;
E[n(t)]=expected number of the removed faults at a time t;
\hat{λ}=scale parameter of the Weibull intensity function, point estimate;
\hat{β}=shape parameter of the Weibull intensity function, point estimate.

The larger the scale parameter, the more spread out the distribution will be, The shape parameter affects the shape of the distribution rather than shifting, stretching or shrinking the distribution.

Embodiments can fit the step Changes to a continuous power-law curve. The number of changes is a result of correcting detected faults. The estimate of the failure rate (the common term for the fault density) \hat{ω}(t) at time t is:

$$\hat{ω} ( t ) = \frac{d }{d t} n ( t ) \\ \hat{ω} ( t ) = \hat{λ} \cdot \hat{β} \cdot {t}^{\hat{β} - 1} \qquad ( 2 )$$

Embodiments can adapt these standards to estimate project reliability by using boundary conditions in the project maturity period to calculate shape and scale parameters of the function. The maturity period is the time while the project is in development before reaching the maturity time, or the time that the failure rate is stable. As discussed in more detail later, embodiments can also include an acceleration parameter when faults are detected more quickly when, for example, many people test a product, as when many people receive copies of a software project.

The boundary conditions can be the time of finding the first failure, and the number of faults remaining at the project maturity time. The project maturity time can be defined by, for example, the time at which the number of remaining faults remains relatively constant; that is, the rate at which faults are fixed and added is about the same. At that time, additional maintenance of the project does not reduce the number of faults. Embodiments can determine the boundary conditions from previous projects, or previously developed systems; embodiments can use the data from previous projects in subsequent projects to model future reliability. Over time, models can average boundary conditions across many projects, which can lead to improved results.

Embodiments can estimate software and hardware improvements to determine reliability growth of an entire integrated system. Embodiments can calculate growth reliability for any duration of maturity period and offer realistic results. These embodiments offer more realistic results than previously possible by combining both hardware and software reliability growth estimates.

Embodiments can account for having more than one copy of the same software in use during maturity period, by mathematically adjust results having more fault information. More fault information is available because there are more users discovering faults more quickly, which can result in a shorter maturity period.

Some embodiments can validate the assumptions of the software size, initial number of faults and degree of improvement at the maturity time. As a project improves, embodiments can validate the reliability model. Validating the model can include comparing the number of expected faults with the actual number of faults. If the model appears slightly off, embodiments can adjust inputs to move the model closer to the actual curve and thereby more accurately predict future results. For example, embodiments can adjust either the scale or the size parameters to adjust the growth reliability model. More typically, however, the model typically does to not need adjustment as it is very accurate.

We can store the verified assumptions in databases for future information. This information can be used as inputs for calculating scale and shape parameters for future models. Collecting verified assumptions, in a database for example, can result in more accurate models for future, similar projects. Similar projects can be, for example, projects from the same development team or a project including similar features or iterations of the same project. The future estimates then can be more accurate for the similar software type.

Reliability functions or failure rates are valid for all stages of the software life cycle: early analysis, test, and finally, reliability growth of software after release. The use of the same function allows integrated assessment of reliability growth of complex systems containing software and hardware components, or other components, such as mechanical components.

Embodiments can determine what the failure rate (i.e., frequency of failures) in a software application or system would be as it matures. Inputs to some embodiments might include the following:
a. Size in thousand source lines of codes, (KiloSLOC), K_{S}
b. Assumed fault density in the software (number of faults per KiloSLOC): ƒ_{D}
c. Initial number of existing faults N=K_{S}·ƒ_{D}
d. The maturity time is T, e.g., time until faults reach a steady state.
e. Remaining number of faults through maturity period, F(t)
f. Assumed Improvement at maturity (fraction of initial faults remaining in the software at maturity): p=F(T)/N

Software faults are solely design related, and are mitigated by changes in the software design. The software failure rate is constant (as it is in hardware) until a design change mitigates an observed fault.

At the mitigation of each observed fault (mitigation of fault) the constant failure rate drops. The resultant failure rate line is a step diagram, with steps at the time of each mitigation—as it is in hardware,

The step line can be fitted to a Weibull intensity function, which is a curve fit of a power-law model, The expected number of failures in time, E[n(t)] is directly proportional (proportionality is scale parameter, λ) to the time raised to a power of another constant (the shape parameter, β). The rate of observed faults is the software failure rate, ω(t), which changes during maturation (first derivative in time of the expected number of observed faults) and when the improvements stop, remains constant.

The following are exemplary embodiments for software reliability assessment or prediction:
Maturity failure rate assessment when test data is not available
Maturity failure detection

Both models use a modified power-law reliability model with a different method of computing the scale and shape parameters. When the test data is not available, the initial overall number of faults is compared to the number of faults at the maturity time. The final (residual number of faults) is reached at the maturity time, at which time further reducing faults is not cost effective. In the case when test data is available, we can calculate parameters from the maximum likelihood equation for the power-law model.

An exemplary embodiment can use a model derived by comparing the number of defects and using a power-law model adapted for early project reliability predictions. The following example discusses a software project, but non-software embodiments are also contemplated. The total number of faults existing in software is a function of its complexity (size), expressed in KiloSLOC (KSLOC) and the fault density.

We can define the initial number of faults as follows:

N₀=K_{S}·ƒ_{D} (3)

where:
N₀=initial total number of faults (at the software release)
K_{S}=Number of KSLOC
ƒ_{D}=fault density

The function parameters, β and λ can be estimated from the initial and final conditions in the maturation period: The first fault is observed at a very short time, t₁. Once parameters are included in the failure rate function, the failure rate of software could then be determined for any time in the maturity period.

E[n(t)]=N₀−N(t)=\hat{λ}·t^{\hat{β}} (4)

### Where:

N(t) is the number of the faults remaining in the software at the time t While the embodiment described above uses faults remaining, other embodiments can include faults removed.

The software instantaneous failure rate during software improvement at a time t is:

$$\hat{ω} ( t ) = \frac{d }{d t} n ( t ) = \frac{d }{d t} [ {N}_{0} - N ( t ) ] = \frac{d }{d t} [ \hat{λ} \cdot {t}^{\hat{β}} ] = \hat{λ} \cdot \hat{β} \cdot {t}^{\hat{β} - 1} \qquad ( 5 )$$

At the maturity time, the final remaining number of faults in the software is annotated as N(T). At that time; the total number of defects would be the expected total number of faults remaining at the maturity time T is N(T).

N₀−N(T)=n(T)=N₀−p·N₀=(1−p)·N₀ (6)

where:
p=fraction of faults remaining in the software after improvements
N(T)=remaining number of faults at the time T

To determine the two unknown parameters of the Weibull intensity function, the shape parameter β and the scale parameter λ, we can define two boundary conditions of the maturity period for which the number of detected faults are known:
The initial boundary condition is the time when the first fault was detected, the very short time after beginning of software observation, t₁:

n(t)=1
The final boundary condition at the maturity, time T, when only a p fraction of the initial number of faults remains in the software and the total number of observed faults would be:

n(T)=N₀−p·N₀.

The shape parameter is then determined from the ratio of the two numbers of removed faults:

$$\frac{\hat{λ} \cdot {t}_{1}^{\hat{β}}}{\hat{λ} \cdot {T}^{\hat{β}}} = \frac{1}{( 1 - p ) \cdot {N}_{0}} \qquad ( 7 )$$

Solving for the point estimate of the shape parameter, β:

$$\hat{β} = \frac{ln ( \frac{1}{( 1 - p ) \cdot {N}_{0}} )}{ln ( {t}_{1} ) - ln ( T )} \qquad ( 8 )$$

The scale parameter is then:

$$\hat{λ} = \frac{( 1 - p ) \cdot {N}_{0}}{{T}^{\hat{β}}} \qquad ( 9 )$$

Parameter p, the percentage of defects remaining at the end of the maturity period T.

To derive the final failure rate (i.e., failure frequency, the inverse of which is the MTFB) at the end of the maturity period T, the scale and shape parameters determined for boundary conditions in this maturity period are included into the failure rate equation:

\hat{ω}(T)=\hat{λ}·\hat{β}·t^{\hat{β}-1} (10)

To solve the eq. 10, one can insert the values for \hat{β} and \hat{λ} from eqs. 8 and 9, respectively.

The projected failure rate at maturity can take into consideration the number of software copies observed in use in the system under analysis because the number of detected and corrected faults will occur faster. In the cases where there are multiple copies, A, observed (used in the systems at the same time), the scale parameter is derived from the total number of observed faults on all of the copies at time T:

$$\begin{matrix}n ( T ) = {\hat{λ}}_{A} \cdot {T}_{1}^{\hat{β}} + {\hat{λ}}_{A} \cdot {T}_{2}^{\hat{β}} + … + {\hat{λ}}_{A} \cdot {T}_{k}^{\hat{β}} … + {\hat{λ}}_{A} \cdot {T}_{A}^{\hat{β}} \\ = {\sum }_{k = 1}^{A} {\hat{λ}}_{A} \cdot {T}_{k}^{β}\end{matrix} \\ {\hat{λ}}_{A} = \frac{n ( T )}{{\sum }_{k = 1}^{A} {T}_{k}^{\hat{β}}} \\ When \text{:} {T}_{1} = {T}_{2} = {T}_{k} = T \\ {\hat{λ}}_{A} = \frac{n ( T )}{A \cdot {T}^{\hat{β}}} \qquad ( 11 )$$

Expressing number of detected faults with the initial number of faults and the fraction remaining, p:

$${\hat{λ}}_{A} = \frac{( 1 - p ) \cdot {N}_{0}}{A \cdot {T}^{\hat{β}}} \qquad ( 12 )$$

The proper scale parameter should be inserted into the failure rate equation when calculated from multiple software copies:

\hat{ω}_{A}(T)=\hat{λ}_{A}·\hat{β}·t^{\hat{β}-1} (13)

Parameter A is an acceleration factor in reliability growth/improvement when the NHPP approach is used to account for planned use, observation, or testing of multiple SW or HW copies or test samples. The copies could provide A times more information on potential faults or A times the number of experienced failures.

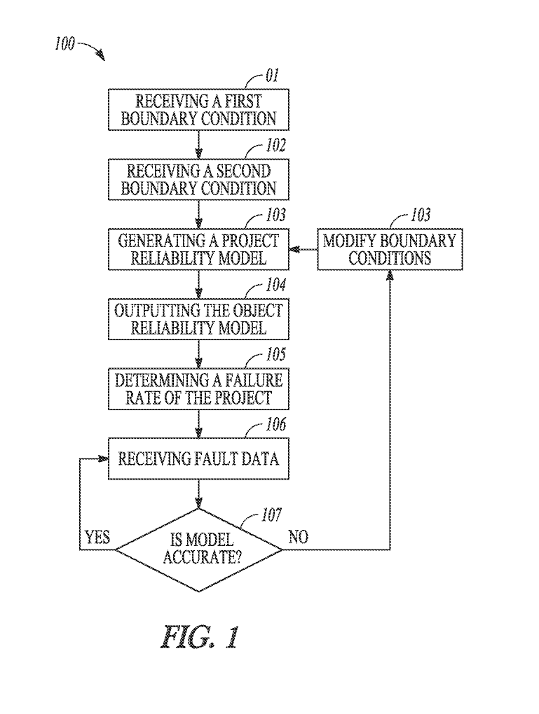

FIG. 1 illustrates flowchart 100, which is a summary of some of the embodiments described above, but is not limited to these embodiments. Step 101 illustrates receiving a first boundary condition, such as t₁, above. Next, step 102 illustrates receiving a second boundary condition, such as T, above. Next, step 103 illustrates using these boundary conditions to generate a project reliability model. The reliability model can then be output via a processor (step 104) to a user as the failure rate (also called failure frequency or failure intensity). The output can be, for example, a dot graph or a curve; other examples include outputting a table or a single value indicating a number of faults estimated to exist. In step 105, the output can be used to determine the failure rate of the project at a given time, either during or after development. Step 106 illustrates receiving actual fault data, which can then be used to verify whether the initial reliability model is accurate. If the model is accurate, we can receive more fault data and continue to verify accuracy. If, however, we the model is inaccurate, we can adjust it by, for example, modifying the boundary conditions (step 108) and regenerating the model,

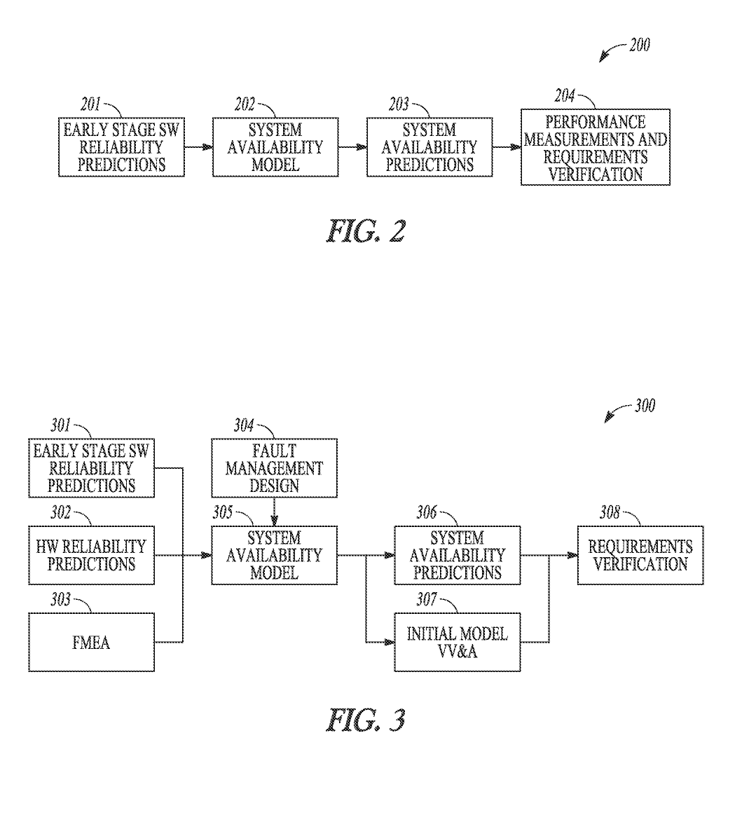

FIG. 2 illustrates a flow chart 200 for using the reliability model generated in FIG. 1, First, step 201 illustrates generating early stage reliability predictions, which in this embodiment are software reliability predictions. Next, embodiments can model system availability, which can include generating models of mean time to repair (MTTR) and mean time between failures (MTBF) (step 202). Step 203 illustrates outputting predictions using the availability models generated in step 202. Finally, embodiments include receiving inputs of performance measurements to verify that the models satisfy requirements (step 204).

Failure rates for hardware and software may be combined as the distributions should be similar but with different parameters, even if the reliability improvements through hardware and software predictions were done separately. By summing the number of expected faults for the hardware and software models, and any other models associated with a particular project or related projects, embodiments can obtain a model for the total number of faults across one or more projects.

Combining reliability models from different components of the same project eliminates the need to monitor each separately. Given the same function type, the joint function parameters may be derived for the entire project. Alternatively, embodiments can separately examine the failure rate of each project component, e.g., hardware and software.

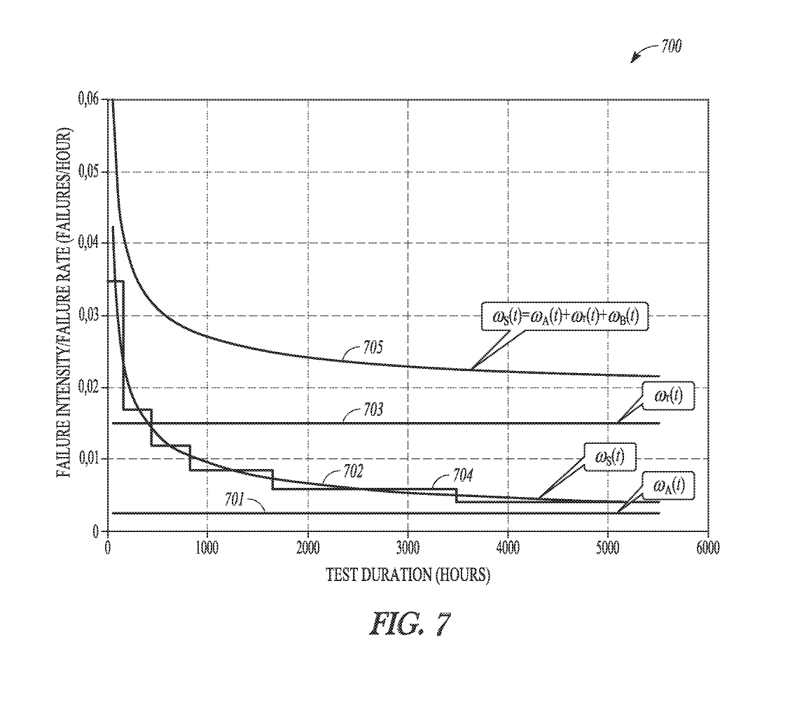

FIG. 7 illustrates a diagram 700 of exemplary failure rates, including a sum of failure rates in a system. Exemplary failure rates for different components, e.g., mechanical, electrical, computer, or software, can be represented by curves 701, 702, and 703. Curve 704 illustrates a step function fit to power-law curve 702. Each step of curve 704 represents the time of fixing one or more faults. Curve 704 represents the actual failure rate, which is determined through test after the project design is complete, whereas curve 702 can be determined before the project is started, i.e., embodiments can provide an early reliability prediction. Curves 701 and 703 can be constant reliability estimates of certain components. Assuming that these components are all related to the same project or system, embodiments include summing the failure rates of these components to yield a summed failure rate 705, or a total failure rate for the project or system,

FIG. 3 illustrates additional embodiments that include combining hardware and software reliability models or predictions (301 and 302), 303 illustrates a Failure Modes and Effects Analysis (FMEA), which is a systematic tool for analytical identification of potential faults and determination and mitigation of their causes. Fault management design 304 can be used to improve the system reliability by mitigation of potential causes of failures after generating the hardware and software reliability models (301 and 302), embodiments can combine them to result in a system availability or reliability model 305. Users can utilize this system reliability or availability model to make predictions (306) of reliability or availability measures at a given time. Additionally, embodiments include a verification, validation and accreditation of the initial model (VV&A) 307. Finally, embodiments can include verifying that the system or any part of it meets requirements 308.

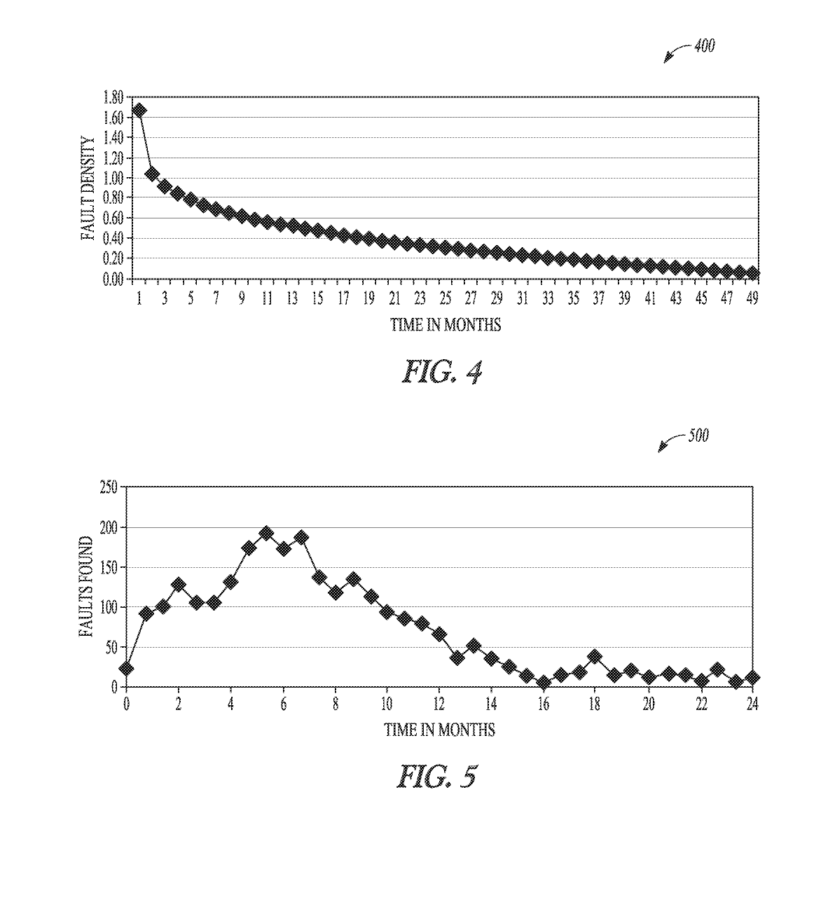

FIG. 4 illustrates an initial reliability model showing fault density at different times. Embodiments can display this data via processor commands to a display or other outputs, such as speakers. From FIG. 3, we see that initial fault density is approximately 1.75 faults/KSLOC. The fault density tapers to about 0.05 faults/KSLOC after 49 months, The shape of this curve is similar to that of the power-law graph.

FIG. 5 illustrates number of faults identified at different times. As discussed above, the maturity time or steady state is the time at which the rate of fixing faults is approximately equal to the rate of injecting faults. The rate of fixing faults results in the fault density curve of FIG. 4.

Embodiments can determine confidence limits by verifying the accuracy of the reliability models. Then, the overall system confidence limits for the failure rate values can also be constructed. Confidence bounds are a function of the statistical model used, e.g., power-law model.

When using commercial-off-the-shelf (COTS) software, it can be valuable to consider its previous use in the industry. As an example, the Linux operating system has been in use for at least 10 years, and the estimated number of released copies (A) might be estimated as a minimum 100,000. The software improvement naturally occurs in steps at each time a fault is fixed. Identification of faults and mitigation of their causes, and therefore fixes, can happen more rapidly as a function of the number of copies tested or observed is use.

If users are testing or utilizing A copies of the same software, then the number of observed faults is far greater, and the scale parameter can adjust accordingly. The number of copies can be used as an “acceleration factor.” In addition to estimating the number of faults during development, embodiments can estimate the number of faults at product release and at the release of each subsequent version.

In the COTS case, the initial number of KSLOC is the starting point at the software release, and the current software Weibull intensity function parameters and the failure rate can be calculated as:

$$\begin{matrix}\hat{β} = \frac{ln ( \frac{1}{( 1 - p ) \cdot {N}_{0}} )}{ln ( {t}_{1} ) - ln ( {T}_{P} )} & ( 14 ) \\ \hat{λ} = \frac{( 1 - p ) \cdot N}{A \cdot {T}_{P}^{\hat{β}}} & ( 15 )\end{matrix}$$

### Where:

T_{P}=length of time in prior use
A=estimated number of copies of the specific COTS software in the field

\hat{ω}(t)=\hat{λ}·\hat{β}·t^{\hat{β}-1} (16)

### EXAMPLE 1

### New Software Failure Rate at the Maturity Time

KSLOC count: 208

Acceleration factor: A=1

SEI level 4=1.0 fault/KSLOC

N₀=1.0·208=208 faults

With the assumptions of t₁=1 sec.= 1/3,600 hour; T=4 years, p=0.03

t₁=2.778·10⁻⁴

T=4·8,760=3.504·10⁴

\hat{β}=0.285

\hat{λ}=10.286

The final failure rate at the maturity time:

$$\hat{ω} ( {T}_{P} ) = \hat{λ} \cdot \hat{β} \cdot {t}^{\hat{β} - 1} = 1.637 \cdot {10}^{- 3} \frac{failures}{hour}$$

### EXAMPLE 2

### COTS Software Reliability

N₀=1.0·20,000,000

A=1,000,000

With the assumptions of t₁=1 sec.= 1/3,600 hour, T_{P}=5 years, p=0.01

$$\hat{β} = \frac{ln ( \frac{1}{( 1 - p ) \cdot {N}_{0}} )}{ln ( {t}_{1} ) - ln ( {T}_{P} )}$$

$$\hat{β} = 0.89$$

$$\hat{λ} = \frac{( 1 - p ) \cdot N}{A \cdot {T}_{P}^{\hat{β}}}$$

$$\hat{λ} = 1.463 \cdot {10}^{- 3}$$

$$\hat{ω} ( {T}_{P} ) = \hat{λ} \cdot \hat{β} \cdot {t}^{\hat{β} - 1} = 4.024 \cdot {10}^{- 4} \frac{failures}{hour}$$

$$MTBF ( {T}_{P} ) = 1 / \hat{ω} ( {T}_{P} ) = 2 , 485 hours$$

In addition, embodiments can estimate the mean time to repair (MTTR), which is typically about minutes or seconds when repair constitutes simply restarting a process or computer. However, MTTR can be greater. Embodiments can receive the MTTR as a input, which can then be used to calculate the percentage down time by multiplying the MTTR by fault density.

Other embodiments can focus on calculating the fault density by severity level. For example, embodiments may only be interested in critical faults, in which case we exclude non-critical faults. In these examples, the fault density will decrease and MTBF will increase because faults will be less frequent.

Considering that at present, the COTS software might no longer be undergoing any significant reliability growth, we can assume that the failure rate is constant. Should reliability grow, embodiments can model reliability growth using the same function scale and shape parameters described above.

Embodiments can include validating the model after receiving actual fault data. To determine parameters of the Weibull intensity function when test data (times to fault observations) are available, embodiments can use the function maximum-likelihood equation. The maximum likelihood for the Weibull intensity function in NHPP is:

$$L = {\hat{λ}}^{M} \cdot {\hat{β}}^{M} \cdot {e}^{- \hat{λ} \cdot {T}^{{\hat{β}}_{.}}} \cdot {\prod }_{i = 1}^{M} {( {t}_{i } )}^{\hat{β} - 1} \qquad ( 17 )$$

### Where:

M=total number of observed/detected and corrected faults
   Taking a logarithm of both sides of the equation (17):

$$Λ = M \cdot ln ( \hat{λ} ) + M ln ( \hat{β} ) - \hat{λ} \cdot {T}^{\hat{β}} + ( \hat{β} - 1 ) \cdot {\sum }_{i = 1}^{M} ln ( {t}_{i } ) \qquad ( 18 )$$

To determine the maximum likelihood value for the point estimate scale parameter, \hat{λ}:

$$\frac{d }{d \hat{λ}} Λ = \frac{M}{\hat{λ}} \cdot {T}^{\hat{β}} = 0 \\ \hat{λ} = \frac{M}{{T}^{\hat{β}}} \qquad ( 19 )$$

### Where:

M=total number of faults detected and addressed
   Shape parameter (point estimate) is determined from the maximum likelihood as follows:

$$\frac{d}{d \hat{β}} Λ = \frac{M}{\hat{β}} - {T}^{\hat{β}} \cdot \hat{λ} \cdot ln ( T ) - {\sum }_{i = 1}^{M} ln ( {t}_{i } ) = {0}^{′} \\ \frac{M}{\hat{β}} - {T}^{\hat{β}} \cdot \frac{M}{{T}^{\hat{β}}} - {\sum }_{i = 1}^{M} ln ( {t}_{i} ) = 0 \\ \hat{β} = \frac{M}{M \cdot ln ( T ) - {\sum }_{i = 1}^{M} ln ( {t}_{i } )} \qquad ( 20 )$$

### Where:

tᵢ=times of fault detection in test

For the unbiased value of the shape and scale parameters:

$$\overline{β} = \frac{M - 1}{M \cdot ln ( T ) - {\sum }_{i = 1}^{M} ln ( {t}_{i} )} \\ \overline{λ} = \frac{M}{{T}^{\overline{β}}} \qquad ( 21 )$$

If there are A copies of tested software then:

$$\overline{λ} = \frac{M}{A \cdot {T}^{\overline{β}}} \qquad ( 22 )$$

Failure rate at maturity:

ω̅(T)= λ̅· β̅·T ^{β̅−1} (23)

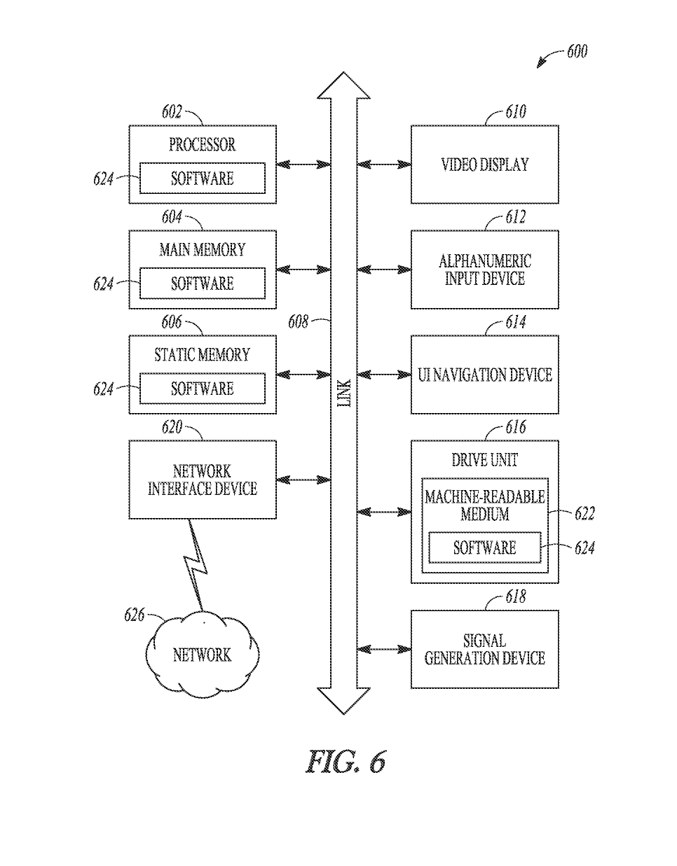

FIG. 6 is a block diagram illustrating a machine in the example form of a computer system 600, within which a set or sequence of instructions for causing the machine to perform any one of the methodologies discussed herein may be executed, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set. (or multiple sets) of instructions to perform any one or more of the methodologies discussed herein.

Example computer system 600 includes at least one processor 602 (e.g., a central processing unit (CPU), a graphics processing unit (CPU) or both, processor cores, compute nodes, etc.), a main memory 604 and a static memory 605, which communicate with each other via a link 608 (e.g., bus). When discussing a processor, a person of ordinary skill in the art would understand that processors can be distributed or networked to each other in one local computer or across several computers connected via a high-speed interface or a network. The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touch screen display. The computer system 600 may additionally include a storage device 615 (e.g., a drive unit), a signal generation device 618 (e.g., a speaker), a network interface device 620, and one or more sensors (not shown), such as a global positioning system (GPS) sensor, compass, accelerometer, or other sensor.

The storage device 615 includes a machine-readable medium 622 on which is stored one or more sets of data structures and instructions 624 (e.g., software) embodying or utilized by any one or more of the methodologies or functions described herein, The instructions 624 may also reside, completely or at least partially, within the main memory 604, static memory 605, and/or within the processor 602 during execution thereof by the computer system 600, with the main memory 604, static memory 605, and the processor 602 constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks; these memories may store data in independent files or databases that can exist on one device or be distributed vie a network, such as an intranet or the Internet.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Examples, as described herein, can include, or can operate on, logic or a number of modules, modules, or mechanisms. Modules are tangible entities capable of performing specified operations and can be configured or arranged in a certain manner. In an example, circuits can be arranged (e.g., internally or with respect to external entities such as other circuits) in a specified manner as a module. In an example, the whole or part of one or more computer systems (e.g., a standalone, client or server computer system) or one or more hardware processors can be configured by firmware or software (e.g., instructions, an application portion, or an application) as a module that operates to perform specified operations. In an example, the software can reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, one instantiation of a module may not exist simultaneously with another instantiation of the same or different module. For example, where the modules comprise a general-purpose hardware processor configured using software, the general-purpose hardware processor can be configured as respective different modules at different times. Accordingly, software can configure a hardware processor, for example, to constitute a particular module at one instance of time and to constitute a different module at a different instance of time.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure. For example, while exemplary embodiments include determining the reliability of hardware and software, additional embodiments can be used to determine how many spare parts to construct based on early reliability estimates in a new system well before the detailed reliability predictions are completed. This can be of extreme value when spare parts of limited supply are considered. Other embodiments can include estimates of quantities of oil available for pumping at some new sites based on early estimates of quantities and depletion rate at similar fields.

The preceding description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments,

The Abstract is provided to comply with 37 C.F.R. § 1.72(b) requiring an abstract that will allow the reader to ascertain the nature of the technical disclosure. It is submitted with the understanding that it will not be used to limit or interpret the scope or meaning of the claims. The following claims are hereby incorporated into the detailed description, with each claim standing on its own as a separate embodiment.

We claim:

1. A method of determining project reliability, the method comprising:
receiving, at a processor, a first boundary condition;
receiving, at the processor, a second boundary condition;
calculating, at the processor, a scale parameter as a function of the first boundary condition;
calculating, at the processor, a shape parameter as a function of the second boundary condition;
generating, via the processor, a project reliability model based on the scale parameter and the shape parameter;
outputting, via the processor, the project reliability model; and
executing, via the processor, the project reliability model to estimate a number of faults in the project at a given time in the future.

2. The method according to claim 1, wherein the first boundary condition comprises a parameter including a time indicating a time of observing a first failure.

3. The method according to claim 1, wherein the second boundary condition comprises a parameter defining a maturity time.

4. The method according to claim 3, wherein the parameter defining the maturity time comprises a fraction of initial faults existing in the project.

5. The method according to claim I, wherein the project reliability model comprises a power-law model.

6. The method according to claim 5, wherein a shape parameter of the power-law model comprises the following equation:
$$\hat{β} = \frac{ln ( \frac{1}{( 1 - p ) \cdot {N}_{0}} )}{ln ( {t}_{1} ) - ln ( T )} ,$$
where
p=a fraction of initial s remaining at a maturity time of the project,
T=a maturity time,
N₀=a initial number of faults in the project, and
t₁=a time of detecting a first fault.

7. The method according to claim 6, wherein the scale parameter of the power-law model comprises the following equation:
$$\hat{λ} = \frac{( 1 - p ) \cdot {N}_{0}}{{T}^{\hat{β}}} .$$

8. At least one non-transitory, machine-readable medium comprising a plurality of instructions that, in response to being executed on a computing device, cause the computing device to perform the acts of:
receiving a first boundary condition;
receiving a second boundary condition;
calculating a scale parameter as a function of the first boundary condition;
calculating a shape parameter as a function of the second boundary condition;
generating a project reliability model based on the scale parameter and the shape parameter;
outputting the project reliability model; and
executing the project reliability model to estimate a number of faults in the project at a given time in the future.

9. The machine-readable medium according to claim 8, wherein the first boundary condition comprises a parameter including a time indicating a time of observing a first failure.

10. The machine-readable medium according to claim 8, wherein the second boundary condition comprises a parameter defining a maturity time.

11. The machine-readable medium according to claim 10, wherein the parameter defining the maturity time comprises a fraction of initial faults existing in the project.

12. The machine-readable medium according to claim 8, wherein the project reliability model comprises a power-law model.

13. The machine-readable medium according to claim 12, wherein the shape parameter of the power-law model comprises the following equation:
$$\hat{β} = \frac{ln ( \frac{1}{( 1 - p ) \cdot {N}_{0}} )}{ln ( {t}_{1} ) - ln ( T )} ,$$
where
p=a fraction of initial faults remaining at a maturity time of the project,
T=a maturity time.
N₀=a initial number of faults in the project, and
t₁=a time of detecting a first fault.

14. The machine-readable medium according to claim 13, wherein the scale parameter of the power-law model comprises the following equation:
$$\hat{λ} = \frac{( 1 - p ) \cdot {N}_{0}}{{T}^{\hat{β}}} .$$

15. A system comprising:
a database storing reliability results for two or more components;
a first component;
a second component; and
a processor configured to use the reliability results to determine a first reliability model of the first component and a second reliability model of the second component;
the processor further configured to sum the first reliability model and the second reliability model to determine a third reliability model.

16. The system according to claim 15, wherein the processor is further configured to calculate the first reliability model using a first boundary condition stored in the database and a second boundary condition stored in the database; and
the processor is further configured to calculate the second reliability model using a third boundary condition stored in the database and a fourth boundary condition stored in the database.

17. The system according to claim 15, wherein the first reliability model represents a curve estimating a number of faults in the first component as a dependent variable and time as an independent variable; and
the second reliability model represents a curve estimating a number of faults in the second component as a dependent variable and time as an independent variable.

18. The system according to claim 15, wherein the processor is further configured to sum the number of faults of the first reliability model with the faults of the second reliability model to determine the third reliability model.

19. The system according to claim 15, wherein the first component is a hardware component.

20. The system according to claim 19, wherein the second component s a hardware component.

21. The system according to claim 19, wherein the second component is a software component.

22. The method according to claim 1 further comprising estimating, via the processor, the mean time between failure,

23. A method of modeling system reliability comprising:
recording, in a memory, a time of detecting a first fault of one or more previously developed systems, wherein the time of detecting the first fault is an average if there are more than one previously developed systems;
recording, in the memory, a maturity time of the one or more previously developed systems, wherein the maturity time is an average if there are more than one previously developed systems;
receiving, at a processor, the time of detecting the first fault;
receiving, at the processor, the maturity time;
calculating, via the processor, a failure frequency modeling system reliability: and outputting, via a display, the failure frequency.
